(19) United States
(12) Patent Application Publication
(10) Pub. No.: US 2025/0365831 A1
(43) Pub. Date: Nov. 27, 2025

(54) DRIVING CIRCUIT FOR LIGHTING AND NIGHTLIGHT LIGHTING AND LIGHTING DEVICE

(71) Applicant: Xiamen Longstar Lighting Co., Ltd., Xiamen (CN)

(72) Inventors: Xilong Li, Xiamen (CN); Kang Wang, Xiamen (CN); Jianwei Zheng, Xiamen (CN); Jianmin Yang, Xiamen (CN); Jiacong Lin, Xiamen (CN); Guofang Wang, Xiamen (CN); Yongxin Liu, Xiamen (CN)

(21) Appl. No.: 19/214,410

(22) Filed: May 21, 2025

(30) Foreign Application Priority Data
May 21, 2024 (CN) 202410631331.9

(51) Int. Cl. H05B 45/3725

(52) U.S. Cl. CPC H05B 45/3725

(57) ABSTRACT

A driving circuit for lighting and nightlight lighting comprising a power control chip, a control chip, a rectifier bridge, a first LED light source, and a second LED light source. An alternating current input end of the rectifier bridge is connected to mains electricity, and a direct current output end of the rectifier bridge is connected to a positive electrode of the first LED light source. The direct current output end of the rectifier bridge is connected to a positive electrode of the second LED light source through a current limiting resistor, and negative electrodes of the first LED light source and the second LED light source are respectively connected to a first switching transistor and a second switching transistor. A signal output end of the control chip is respectively connected to control electrodes of the first switching transistor and the second switching transistor.

### RELATED APPLICATIONS

This application claims priority to Chinese patent application number 202410631331.9, filed on May 21, 2024. Chinese patent application number 202410631331.9 is incorporated herein by reference.

### FIELD OF THE DISCLOSURE

The present disclosure relates to a driving circuit and in particular to a driving circuit for lighting and nightlight lighting.

### BACKGROUND OF THE DISCLOSURE

A triode for alternating current dimmable (TRIAC-dimmable) downlight with a night light function currently employs a design where main lighting and night light operate as two independent systems. The wall switch actions are sampled by a sampling circuit, converted into electrical control signals, and used to selectively activate these two systems: main lighting ON/night light OFF; main lighting OFF/night light ON; or both systems ON. This state switching occurs without affecting an ability of a dimmer to control dimming performance of the dimmer.

A drawback of the existing design is that the requirement for two independent power supply systems (one for main lighting and another for the night light) increases circuit complexity, raises production challenges, and complicates miniaturization. In applications demanding ultra-thin or compact designs, such complexity becomes a critical limitation for market adaptability.

### BRIEF SUMMARY OF THE DISCLOSURE

The technical problem to be solved by the present disclosure is to provide a driving circuit for lighting and nightlight lighting, and a power supply can be used to realize power supplying of nightlight lighting and lighting.

In order to solve the above technical problems, the present disclosure provides a driving circuit for lighting and nightlight lighting comprising a power control chip, a control chip, a rectifier bridge, a first light-emitting diode (LED) light source, and a second LED light source.

An alternating current input end of the rectifier bridge is connected to mains electricity, and a direct current output end of the rectifier bridge is connected to a positive electrode of the first LED light source. The direct current output end of the rectifier bridge is connected to a positive electrode of the second LED light source through a current limiting resistor.

Negative electrodes of the first LED light source and the second LED light source are respectively connected to a first switching transistor and a second switching transistor, and a signal output end of the control chip is respectively connected to control electrodes of the first switching transistor and the second switching transistor.

A withstand voltage of the first switching transistor and a withstand voltage of the second switching transistor are respectively less than a working voltage of the first LED light source and a working voltage of the second LED light source.

In a preferred embodiment, the current limiting resistor comprises at least two resistors connected in series.

In a preferred embodiment, the negative electrodes of the first LED light source and the second LED light source are connected to floating ground respectively through the first switching transistor and the second switching transistor.

In a preferred embodiment, the power control chip and the control chip are respectively connected to the floating ground.

In a preferred embodiment, potential of the floating ground is higher than potential of a negative terminal of the direct current output end of the rectifier bridge.

The present disclosure provides a lighting device comprising the driving circuit for lighting and nightlight lighting.

Compared with the existing techniques, the technical solution has the following advantages.

The present disclosure provides the driving circuit for lighting and nightlight lighting, which reduces the current flowing through the second LED light source by adopting the current limiting resistor, thereby reducing the brightness of the second LED light source to achieve a purpose of nightlight lighting. In this way, the first LED light source and the second LED light source can be directly connected to a positive terminal of the direct current output end of the rectifier bridge, and there is no need to set up two sets of power supply circuits.

The present disclosure provides the driving circuit for lighting and nightlight lighting, and the withstand voltage of the first switching transistor and the withstand voltage of the second switching transistor are selected to be less than the working voltages of the LED light sources. In this way, the first switching transistor and the second switching transistor can be in a state of primary breakdown, but the current flowing through the first LED light source and the second LED light source is relatively small. The first LED light source and the second LED light source are still in a state of appearing to be turned off until the control chip controls the first switching transistor and the second switching transistor to be turned on, at which time the first LED light source and the second LED light source will light up. In this way, the switching transistors with relatively low withstand voltages can be selected, thereby reducing costs.

### BRIEF DESCRIPTION OF THE DRAWINGS

FIG. 1 illustrates a circuit diagram of a preferred embodiment of the present disclosure.

### DETAILED DESCRIPTION OF THE EMBODIMENTS

The embodiments of the present disclosure will be clearly and completely described below in conjunction with the drawings in the embodiments of the present disclosure. It is obvious that the described embodiments are only part of the embodiments of the present disclosure, rather than all the embodiments. All other embodiments obtained by ordinary technicians in this field based on the embodiments of the present disclosure without making creative work are within the scope of protection of the present disclosure.

In the present disclosure, it should be noted that the terms “upper”, “lower”, “inner”, “outer”, “top”, “bottom”, and the like indicate positions or positional relationships based on the positions or positional relationships shown in the drawings, and are only for the convenience of describing the present disclosure and simplifying the description, rather than indicating or implying that the device or element referred to must have a specific position, be constructed and operated in a specific position, and therefore should not be understood as limiting the present disclosure. In addition, the terms “first” and “second” are used for descriptive purposes only and should not be understood as indicating or implying relative importance.

In the present disclosure, it should be noted that, unless otherwise clearly stipulated and limited, the terms “installed”, “provided with”, “mounted”, “connected”, etc. should be understood in a broad sense. For example, “connection” can be a wall-mounted connection, a detachable connection, or an integral connection. It can be a mechanical connection or an electrical connection. It can be a direct connection or an indirect connection through an intermediate medium. It can be the internal connection of two components. For technicians of ordinary skill in this field, the specific meanings of the above terms in the present disclosure can be understood according to specific circumstances.

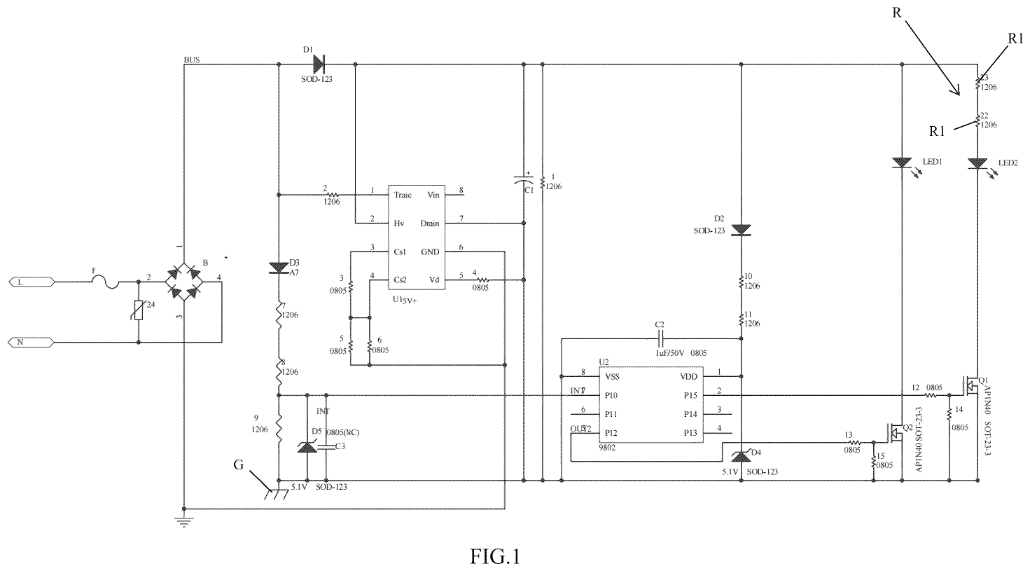

Referring to FIG. 1, this embodiment provides a driving circuit for conventional lighting and nightlight lighting, and the driving circuit comprises a power control chip U1, a control chip U2, a rectifier bridge B, a first light-emitting diode (LED) light source LED1, and a second LED light source LED2.

An alternating current input end of the rectifier bridge B is connected to mains electricity, a direct current output end of the rectifier bridge B is connected to a positive electrode of the first LED light source LED1, and the direct current output end of the rectifier bridge B is also connected to a positive electrode of the second LED light source LED2 through a current limiting resistor R.

Negative electrodes of the first LED light source LED1 and the second LED light source LED2 are respectively connected to a first switching transistor Q2 and a second switching transistor Q1. A signal output end of the control chip U2 is respectively connected to control electrodes of the first switching transistor Q2 and the second switching transistor Q1.

When working, the power control chip U1 is configured as a power control circuit to supply power to the first LED light source LED1 and the second LED light source LED2. The control chip U2 is configured to sample a BUS voltage signal to control the second switching transistor Q1 and the first switching transistor Q2, and the second switching transistor Q1 and the first switching transistor Q2 are configured to respectively control turning on and off of the first LED light source LED1 and the second LED light source LED2.

In this embodiment, the current limiting resistor R comprises at least two resistors R1 connected in series, and a single resistor can also be used, as long as a resistance value and load power enable brightness of the second LED light source LED2 to be reduced to achieve a purpose of nightlight lighting, which is a simple replacement of this embodiment. By adopting the current limiting resistor R, current flowing through the second LED light source LED2 is reduced, thereby reducing the brightness of the second LED light source LED2 to achieve the purpose of nightlight lighting. In this way, the first LED light source LED1 and the second LED light source LED2 can be directly connected to a positive terminal of the direct current output end of the rectifier bridge, and there is no need to set up two sets of power supply circuits. In other words, compared with directly selecting a low-voltage LED light source in the prior art, a high-voltage LED light source like conventional lighting is selected in this embodiment, but the current flowing through the second LED light source LED2 is reduced by the current limiting resistor R, so that the second LED light source LED2 will not be fully lit. Thus, an effect of nightlight lighting can be achieved. Since the first LED light source LED1 and the second LED light source LED2 are both high-voltage LED light sources, the first LED light source LED1 and the second LED light source LED2 can share a same power supply.

In this embodiment, the negative electrodes of the first LED light source LED1 and the second LED light source LED2 are connected to floating ground G respectively through the first switching transistor Q2 and the second switching transistor Q1. The power control chip U1 and the control chip U2 are respectively connected to the floating ground G. Potential of the floating ground G is higher than potential of a negative terminal of the direct current output end of the rectifier bridge.

In addition, in this embodiment, a withstand voltage of the first switching transistor Q2 and a withstand voltage of the second switching transistor Q1 are respectively less than a working voltage of the first LED light source LED1 and a working voltage of the second LED light source LED2. In this way, the first switching transistor Q2 and the second switching transistor Q1 can be in a state of primary breakdown, but the current flowing through the first LED light source LED1 and the second LED light source LED2 is relatively small, and the first LED light source LED1 and the second LED light source LED2 are still in a state of appearing to be turned off until the control chip U2 controls the first switching transistor Q2 or the second switching transistor Q1 to be turned on, at which time the first LED light source LED1 and the second LED light source LED2 will light up. In this way, the first switching transistor Q2 or the second switching transistor Q1 with relatively low withstand voltages can be selected, thereby reducing costs. Because the first LED light source LED1 and the second LED light source LED2 are both high-voltage LED light sources, it is not necessary to use high-voltage-resistant switching transistors, which increase costs.

The above is only a preferred specific implementation of the present disclosure, but the design concept of the present disclosure is not limited to this. Any technician familiar with the technical field who uses this concept to make non-substantial changes to the present disclosure within the technical scope disclosed by the present disclosure shall be deemed to infringe the protection scope of the present disclosure.

What is claimed is:

1. A driving circuit for lighting and nightlight lighting, comprising:
a power control chip,
a control chip,
a rectifier bridge,
a first light-emitting diode (LED) light source, and
a second LED light source, wherein:
an alternating current input end of the rectifier bridge is connected to mains electricity,
a direct current output end of the rectifier bridge is connected to a positive electrode of the first LED light source,
the direct current output end of the rectifier bridge is connected to a positive electrode of the second LED light source through a current limiting resistor,
negative electrodes of the first LED light source and the second LED light source are respectively connected to a first switching transistor and a second switching transistor,
a signal output end of the control chip is respectively connected to control electrodes of the first switching transistor and the second switching transistor, and
a withstand voltage of the first switching transistor and a withstand voltage of the second switching transistor are respectively less than a working voltage of the first LED light source and a working voltage of the second LED light source.

2. The driving circuit for lighting and nightlight lighting according to claim 1, wherein:
the current limiting resistor comprises at least two resistors connected in series.

3. The driving circuit for lighting and nightlight lighting according to claim 1, wherein:
the negative electrodes of the first LED light source and the second LED light source are connected to floating ground respectively through the first switching transistor and the second switching transistor.

4. The driving circuit for lighting and nightlight lighting according to claim 3, wherein:
the power control chip and the control chip are respectively connected to the floating ground.

5. The driving circuit for lighting and nightlight lighting according to claim 3, wherein:
potential of the floating ground is higher than potential of a negative terminal of the direct current output end of the rectifier bridge.

6. A lighting device comprising the driving circuit for lighting and nightlight lighting according to claim 1.

7. A lighting device comprising the driving circuit for lighting and nightlight lighting according to claim 2.

8. A lighting device comprising the driving circuit for lighting and nightlight lighting according to claim 3.

9. A lighting device comprising the driving circuit for lighting and nightlight lighting according to claim 4.

10. A lighting device comprising the driving circuit for lighting and nightlight lighting according to claim 5.
